(19) United States
(12) Patent Application Publication
(10) Pub. No.: US 2007/0074260 A1
(43) Pub. Date: Mar. 29, 2007

(54) Method and apparatus for providing content using a distribution network

(75) Inventor: Erik Elstermann, Carlsbad, CA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(73) Assignee: General Instrument Corporation

(21) Appl. No.: 11/236,292

(22) Filed: Sep. 27, 2005

(51) Int. Cl. H04N 7/173; H04N 7/20; H04N 7/16

(52) U.S. Cl. 725/117; 725/115; 725/67; 725/147

(57) ABSTRACT

A method and apparatus for utilizing at least one packet stream at a regional site is described. In one embodiment, at least one packet stream is multicast from a master headend. A request is then submitted to access one of the packet stream(s) located at a multicast endpoint. The packet stream(s) is subsequently received at the regional site. The packet stream(s) is then processed and subsequently provided to a delivery network.

### BACKGROUND OF THE INVENTION

1. Field of the Invention

Embodiments of the present invention generally relate to digital distribution networks. More specifically, the present invention relates to a method and apparatus for providing content using a distribution network.

2. Description of the Related Art

Presently, content distribution networks are characterized by centralized architectures that typically include a central satellite downlink (e.g., a “master headend”) used to deliver content (e.g., programs) to multiple downstream regional redistribution points (e.g., “regional hubs”). Notably, the central satellite downlink is typically used to feed a unique content stream to each respective regional hub, which enables program provider control to be exercised over receiving devices (e.g., integrated receiver decoders) that solely reside in the master headend. Each receiving device delivers a single-program transport stream (SPTS) to an associated regional hub, where it is processed for delivery to an end-user. However, the described centralized structure is not without its disadvantages. Namely, decryption operations must be performed at the master headend, which consequently exposes the content to the distribution network unless additional security measures are implemented. The implementation of these additional security measures would require other infrastructure components and contribute to added costs. Secondly, inefficient distribution and usage of network bandwidth typically occurs in every instance where two or more regions are supplied with the same content. Similarly, fault management is complicated since protection must be provided for each region's SPTS regardless of conveyed content.

Thus, there is a need in the art for a more effective method and apparatus for providing satellite-based content using a distribution network.

### SUMMARY OF THE INVENTION

A method and apparatus for utilizing at least one packet stream at a regional site is described. In one embodiment, at least one packet stream is multicast from a master headend to a distribution network. A request is then submitted by a receiving device (e.g., an integrated receiver decoder) to access one of the packet stream(s) located at a multicast endpoint. The packet stream(s) is subsequently received by the receiving device at the regional site. The packet stream(s) is then processed and subsequently provided to a delivery network.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block diagram of broadcast distribution network in accordance with the present invention;

FIG. 2 depicts a block diagram of a detailed operation of a broadcast distribution network in accordance with the present invention;

FIG. 3 depicts a method for providing satellite content over a distribution network in accordance with the present invention; and

FIG. 4 is a block diagram depicting an exemplary embodiment of a computer suitable for implementing the processes and methods described herein.

To facilitate understanding, identical reference numerals have been used, wherever possible, to designate identical elements that are common to the figures.

### DETAILED DESCRIPTION

A method and apparatus for providing satellite-based content using a distribution network is described. More specifically, the invention extends integrated receiver decoder (IRD) functionality into Internet Protocol (IP)-based distribution networks, allowing for the real-time program provider control of content that is delivered to regional end-users through a central “master” headend. Namely, IRD functionality is dispersed across the distribution network such that any reception and demodulation operations are performed at the central master headend, while program selection, decryption, and decoding procedures are all executed at regional facilities. The present invention enables the programming provider to remotely and dynamically control the content supplied to each hub for subsequent distribution to the end-users (e.g., sports event blackout).

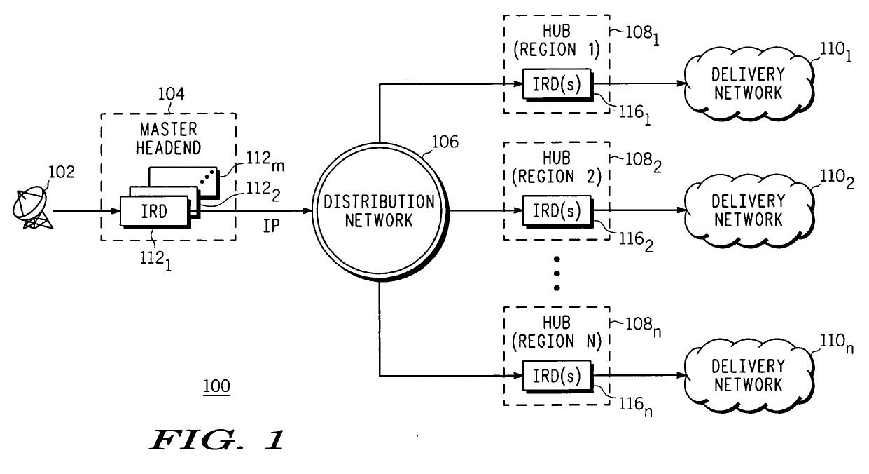

FIG. 1 depicts one embodiment of a content distribution system 100, which includes a satellite signal receiver 102, master headend 104, a distribution network 106, a plurality of regional hubs 108_{1 . . . n}, and a corresponding plurality of delivery networks 110_{1 . . . n}. The master headend 104 comprises a plurality of receiving devices 112_{1 . . . m}, e.g., IRDs, each of which receives a signal from a unique satellite transponder via the satellite signal receiver 102. Each satellite signal includes a plurality of program streams in the form of a single multiple-program transport stream (MPTS) In addition, each of the plurality of IRDs 112_{1 . . . m} at the master headend 104 is responsible for demodulating the satellite-delivered MPTSs for delivery to the distribution network 106 (e.g., an IP network or an Asynchronous Transport Mode (ATM) network). The distribution network 106 connects the master headend 104 with the plurality of regional hubs 108_{1 . . . n} and is responsible for providing the MPTS to a requesting regional receiving device 116, e.g., an IRD. Once the MPTS is received at a requisite regional hub 108, the corresponding IRD 116 decrypts the transport stream and subsequently provisions it to the delivery network 110 to be distributed to at least one endpoint device (e.g., a set top box). Although only one IRD per regional hub is depicted in FIG. 1, one skilled in the art realizes that a plurality of IRDs may also exist at a given regional hub.

Advantages of implementing this type of architecture include the propagation of satellite encryption through the distribution network to a regional hub, i.e., content protection is maintained within the distribution network. Therefore, this architecture effectively eliminates the need for extraneous encryption since the multiplex signal is already encrypted. Similarly, fault management is simplified since MPTSs are received at the distribution network (i.e., one stream per satellite transponder) as opposed to a multitude of signal streams provided to all the regional hubs. Lastly, the architecture can also be characterized as being bandwidth-efficient since duplicate programming is not routed through the distribution network. Thus, the network bandwidth is reduced due to a reduction in the number of streams delivered to all hubs.

In one embodiment of the present invention, each IRD 112_{1 . . . m} at the master headend 104 receives a satellite multiplex signal (i.e., an MPTS) from a satellite transponder via the satellite signal receiver 102 and subsequently demodulates (using a demodulating component) the received signal in order to acquire the data transmitted by the satellite transponder. This MPTS is then packetized to form a packet stream (e.g., IP packets) by the IRD 112 for transmission over the distribution network (e.g., an IP network). The MPTS may be a Moving Picture Expert Group (MPEG)-2 transport stream, MPEG-4 transport stream, and the like. These packet streams may include MPEG-2 transports streams, MPEG-4 transport streams, and the like. The IRD 112 multicasts the packet stream to the distribution network 106 via a specific address as described below.

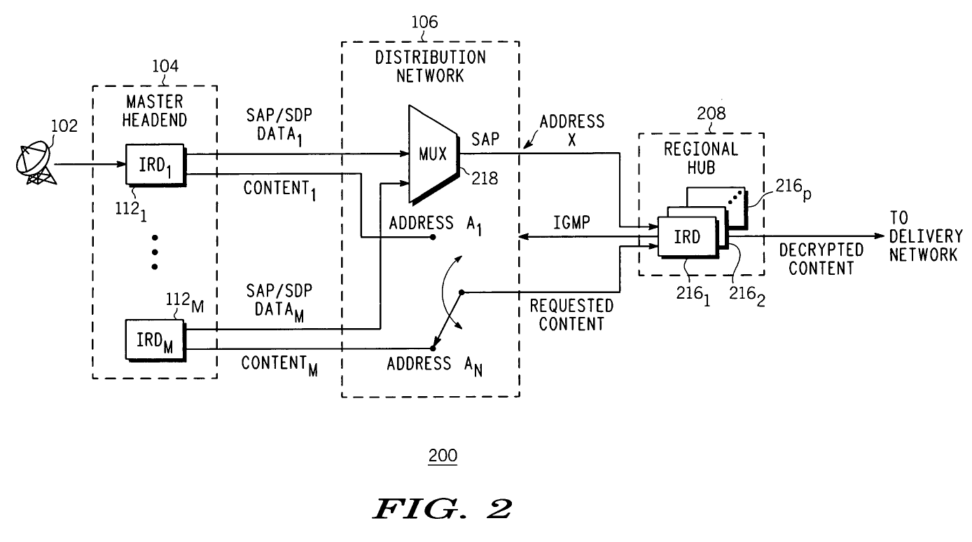

FIG. 2 illustrates the logical operation of the distribution network 106. Whenever possible, FIG. 2 utilizes identical reference numerals to designate identical elements that are common to FIG. 1. However, FIG. 2 illustrates a regional hub 208 and a corresponding set of regional IRDs 216_{1 . . . p}, which may represent any of the regional hubs 108_{1 . . . n} and corresponding set of regional IRDs 116 (e.g., 116₁), respectively. In addition to multicasting the content packet stream, each IRD 112_{1 . . . m} at the master headend 104 also multicasts a Session Announcement Protocol (SAP) message to the distribution network 106. Notably, each IRD 112_{1 . . . m} multicasts a session announcement to a multicast endpoint, which is normally a “well-known” address/port (e.g., 224.2.127.254/9875), in accordance to methods that are well-known in the art. The session announcement is a repeated message that pinpoints the location (i.e., the specific address/port) where the content packet stream may be found as well as the satellite and transponder that are responsible for providing the original multiplex signal. The SAP data also contains Session Description Protocol (SDP) data. More specifically, SDP data describes the details of the transmission, such as the format, the timing and authorship of the transmission, the name and purpose of the session, the version number, contact information, and the like.

At some time, the IRD 216 (i.e., any one of the IRDs 216_{1 . . . p}) learns of and obtains the address/port that is associated with the SAP announcement. This address may be acquired upon the activation (i.e., boot up procedure) of the IRD 216 or some other well-known means in the art. Once tuned to the appropriate address, the IRD 216 is provided the location of the packet stream that contains the content (e.g., a particular program) desired by an end-user.

In one exemplary scenario, IRD 112₁, in FIG. 2 receives a multiplex signal from a particular satellite transponder and subsequently provides the content of the multiplex signal to the distribution network 106 at address “A₁”. Similarly, SAP/SDP data pertaining to this content is provided by the IRD 112₁ to a multiplexer/combination device 218 in the distribution network which combines the SAP/SDP data from all the master headend IRDs into a single flow SAP announcement, which is placed at address “X” (i.e., a “well-known” address).

After the combined SAP announcement is placed at address “X”, a regional IRD 216 accesses this information and selects the appropriate MPTS to process in response to static or dynamic requests for a specific content signal by the system operator or programming provider. In one embodiment, the IRD 216 first uses an Internet Group Management Protocol (IGMP) message to request that the distribution network provide the SAP announcement located at a multicast endpoint designated by the well-known address (e.g., address “X”) to the IRD 216. After tuning to the appropriate address and receiving the SAP announcement, the IRD 216 learns that the content request by an IRD operator (e.g., a multiple system operator (MSO)) or programming provider is located at another address specified in the SAP announcement. The IRD 216 transmits another IGMP message to the distribution network requesting to join the multicast endpoint with the desired content (e.g., address “A₁”). In response, the distribution network forwards the content located at address A₁ to the requesting IRD 216. The IRD 216 then decrypts the packet stream with a decryption component and subsequently decodes the content embedded in the received multiplex signal with a decoder. Lastly, the IRD 216 forwards at least one signal stream from the multiplex signal to the delivery network 106.

The present invention may also be utilized to remotely control the IRDs 116_{1 . . . n} located at the regional hubs. Notably, control commands (e.g., retune information) are embedded into the multiplex signal which propagates through. the master headend 104 to a regional IRD 116. These control commands are typically regional IRD-specific in the sense that only a particular regional IRD (or IRDs) complies with the instructions detailed in the commands. For example, a given regional IRD (which has previously been assigned a location identifier) that is currently tuned to a signal stream from address “A₁” may receive a signal with an embedded control command that instructs a regional IRD with a particular identifier (or IRDs with particular identifiers) to switch to channel “A₄”. If the location identifier of the regional IRD is identical to the identifier embedded in the control command, then that regional IRD will comply with the instruction and tune to channel A₄ to receive a new packet stream. This remote retuning feature conserves bandwidth since it is not necessary to transmit each and every MPTS to the regional IRD.

In one embodiment of the present invention, the regional hub comprises a regional IRD for each channel that is provided to the delivery network. Notably, an IRD extracts the appropriate signal from the MPTS and subsequently decrypts, decodes and converts the signal to an analog signal. The analog signal is then provided to the customer via a cable delivery network.

In another embodiment, the regional hub comprises a regional IRD that is digitally provided to the customer via a digital cable system. In this scenario, the regional IRD extracts the appropriate signal from the MPTS and then decrypts and embeds the signal into a single program transport stream (SPTS). The regional IRD then forwards the SPTS to the customer. Additionally, the SPTS (along with other SPTSs) may also be re-multiplexed into a new MPTS for delivery as a digital service via a digital cable network. In yet another embodiment, the SPTS may be forwarded directly to the customer via an Internet Protocol delivery network (e.g., xDSL).

FIG. 3 illustrates a method 300 for utilizing satellite content over a distribution network in accordance with the present invention. Method 300 begins at step 302 and proceeds to step 304, where at least one request to access a packet stream at a multicast endpoint is made. In one embodiment, an IRD at a regional hub submits an IGMP message to the delivery network to access a particular channel (i.e., packet stream content). Typically, an operator (e.g., MSO) or programming provider issues a control command to a regional IRD. The regional IRD then processes the control command and transmits an associated IGMP message to the delivery network as a request to access the SAP announcement address/port. The SAP announcement contains data that details the location of the multicast endpoint carrying the content corresponding to the request made by the MSO or programming provider. Once access is granted and the requisite data is accessed, the IRD transmits a second IGMP message to the delivery network requesting access to the address/port that contains the desired content.

At step 306, a packet stream is received at a regional site associated with the requesting IRD. In one embodiment, the delivery network receives the IRD's IGMP message and permits the IRD to access the requisite address/port that contains the desired content. Once the virtual connection is made, the packet stream flows directly from the distribution network 106 to the regional IRD 216.

At step 308, the received packet stream is processed. In one embodiment, the IRD processes the received packet stream by initially decrypting the incoming packet stream to remove the original encryption applied to the signal prior to its reception at the downlink station. Once the encryption is removed, the IRD decodes the packet stream in order to acquire the specific signal stream that was requested by the original control command issued from an operator or program provider. The IRD typically decodes the signal by selecting the appropriate signal stream from the plurality of streams within the MPTS.

At step 310, the processed packet stream is provided to the delivery network. In one embodiment, the regional IRD forwards the necessary signal stream from the MPTS to the delivery network for further distribution, e.g., to at least one endpoint device, such as a set top box. The method 300 then ends at step 312.

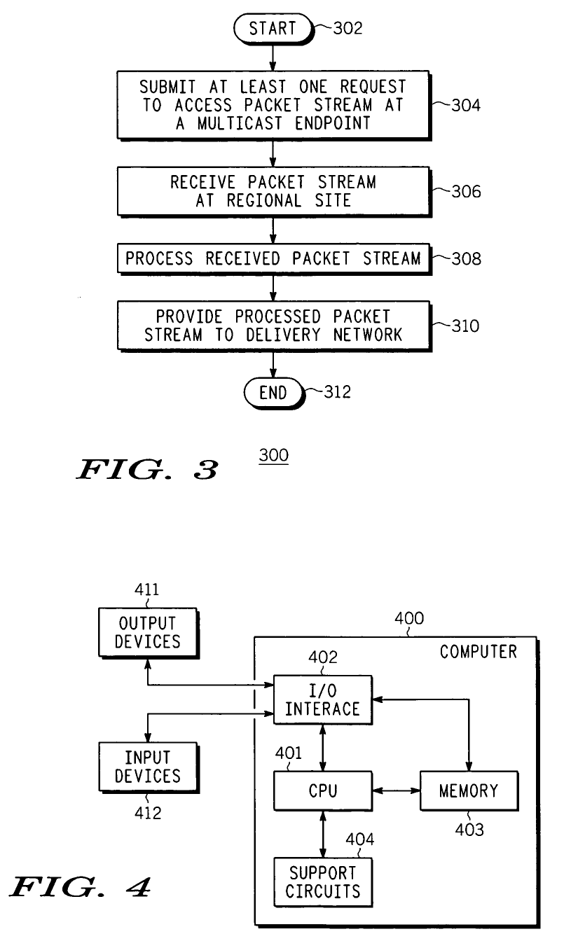

FIG. 4 is a block diagram depicting an exemplary embodiment of a computer 400 suitable for implementing the processes and methods described herein. The computer 400 may comprise any of the IRDs depicted in FIG.1 and FIG. 2. The computer 400 includes a central processing unit (CPU) 401, a memory 403, various support circuits 404, and an I/O interface 402. The CPU 401 may be any type of microprocessor known in the art. The support circuits 404 for the CPU 401 include conventional cache, power supplies, clock circuits, data registers, I/O interfaces, and the like. The I/O interface 402 may be directly coupled to the memory 403 or coupled through the CPU 401. The I/O interface 402 may be coupled to various input devices 412 and output devices 411, such as a conventional keyboard, mouse, printer, display, and the like.

The memory 403 may store all or portions of one or more programs and/or data to implement the processes and methods described herein. Notably, the memory 403 may store the requisite software that is capable of distributing data as described above. Although one or more aspects of the invention are disclosed as being implemented as a computer executing a software program, those skilled in the art will appreciate that the invention may be implemented in hardware, software, or a combination of hardware and software. Such implementations may include a number of processors independently executing various programs and dedicated hardware, such as ASICs.

The computer 400 may be programmed with an operating system, which may be OS/2, Java Virtual Machine, Linux, Solaris, Unix, Windows, Windows95, Windows98, Windows NT, and Windows2000, WindowsME, and WindowsXP, among other known platforms. At least a portion of an operating system may be disposed in the memory 403. The memory 403 may include one or more of the following: random access memory, read only memory, magneto-resistive read/write memory, optical read/write memory, cache memory, magnetic read/write memory, and the like, as well as signal-bearing media as described below.

An aspect of the invention is implemented as a program product for use with a computer system. Program(s) of the program product defines functions of embodiments and can be contained on a variety of signal-bearing computer readable media and/or carrier(s), which include, but are not limited to: (i) information permanently stored on non-writable storage media (e.g., read-only memory devices within a computer such as CD-ROM or DVD-ROM disks readable by a CD-ROM drive or a DVD drive); (ii) alterable information stored on writable storage media (e.g., floppy disks within a diskette drive or hard-disk drive or read/writable CD or read/writable DVD); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct functions of the invention, represent embodiments of the invention.

While the foregoing is directed to embodiments of the present invention, other and further embodiments of the invention may be devised without departing from the basic scope thereof, and the scope thereof is determined by the claims that follow.

1. A content distribution system, comprising:
a master headend that comprises at least one receiving device for receiving a satellite signal, demodulating said satellite signal, and packetizing content of said satellite signal into a packet stream to be transported over a distribution network; and
at least one regional receiving device for receiving said packet stream from said distribution network, decrypting said content in said packet stream, decoding said content in said decrypted packet stream, and transmitting at least a portion of said content of said decoded packet stream.

2. The system of claim 1, wherein each of said satellite signal and said packet stream comprises at least one of: a Moving Picture Experts Group (MPEG)-2 signal or an MPEG-4 signal.

3. The system of claim 1, wherein said distribution network comprises at least one of: an Internet Protocol (IP) network or an Asynchronous Transport Mode (ATM) network.

4. The system of claim 1, wherein said distribution network receives said packet stream from said at least one receiving device and assigns said packet stream to a multicast endpoint.

5. The system of claim 1, wherein each of said satellite signal and said content of said packet stream comprises a multiple program transport stream (MPTS).

6. The system of claim 1, wherein said master headend transmits a second packet stream comprising Session Announcement Protocol (SAP) data and Session Description Protocol (SDP) data over said distribution network.

7. The system of claim 1, wherein said at least one signal stream of said decoded packet stream is transmitted to a delivery network for distribution to at least one endpoint device.

8. The system of claim 1, wherein each of said at least one receiving device and said at least one region receiving device comprises at least one integrated receiver decoder (IRD).

9. A method for utilizing at least one packet stream at a regional site, comprising:
multicasting said at least one packet stream from a master headend via a distribution network;
submitting a request to access one of said at least one packet stream at a multicast endpoint;
receiving said one of said at least one packet stream at said regional site;
processing said one of said at least one packet stream; and
providing said processed one of said at least one packet stream packet stream to a delivery network.

10. The method of claim 9, wherein said signal comprises at least one of: an Moving Picture Experts Group (MPEG)-2 signal or an MPEG-4 signal.

11. The method of claim 9, wherein said distribution network comprises at least one of: an Internet Protocol (IP) network or an Asynchronous Transport Mode (ATM) network.

12. The method of claim 9, wherein said processing step comprises:
decrypting said received one of said at least one packet stream to form a decrypted packet stream; and
decoding said decrypted one of said at least one packet stream to form a decoded packet stream.

13. The method of claim 12, further comprising:
transmitting at least a portion of said decoded one of said at least one packet stream to said delivery network for distribution to at least one endpoint device.

14. The method of claim 13, wherein said at least one endpoint device comprises at least one set top box.

15. An apparatus for utilizing at least one packet stream at a regional site, comprising:
means for multicasting said at least one packet stream from a master headend;
means for submitting a request to access one of said at least one packet stream at a multicast endpoint;
means for receiving said one of said at least one packet stream at said regional site;
means for processing said one of said at least one packet stream; and
means for providing said processed one of said at least one packet stream packet stream to a delivery network.

16. The apparatus of claim 15, wherein said signal comprises at least one of: a Moving Picture Experts Group (MPEG)-2 signal or an MPEG-4 signal.

17. The apparatus of claim 15, wherein said at least one packet network comprises at least one of: an Internet Protocol (IP) network or an Asynchronous Transport Mode (ATM) network.

18. The apparatus of claim 15, wherein means for processing comprises:
means for decrypting said received one of said at least one packet stream to form a decrypted packet stream; and
means for decoding said decrypted one of said at least one packet stream to form a decoded packet stream.

19. The apparatus of claim 18, further comprising:
means for transmitting at least a portion of said decoded one of said at least one packet stream to said delivery network for distribution to at least one endpoint device.

20. The apparatus of claim 19, wherein said at least one endpoint device comprises at least one set top box.
